(19) United States
(12) Patent Application Publication
(10) Pub. No.: US 2025/0326437 A1
(43) Pub. Date: Oct. 23, 2025

(54) VEHICLE BODY COMPONENT HAVING A VARIABLE LATTICE BODY HEADLINER

(71) Applicant: Ford Global Technologies, LLC, Dearborn, MI (US)

(72) Inventors: Keith Weston, Canton, MI (US); David D. Friske, Wolverine Lake, MI (US); Michael Joseph Niksa, Royal Oak, MI (US); Lorne Forsythe, Wind Lake, WI (US)

(21) Appl. No.: 18/638,016

(22) Filed: Apr. 17, 2024

(51) Int. Cl. B62D 21/08; B60Q 3/20; B60R 13/02

(52) U.S. Cl. CPC B62D 21/08; B60Q 3/20; B60R 13/0225; B60R 2013/0287; B60R 2013/0293

(57) ABSTRACT

A vehicle body component includes a variable lattice body having a front side exposed to an interior environment of a vehicle and a plurality of segments connected to each other to define a plurality of voids forming an irregular lattice structure configured to twist on itself responsive to a vibrational energy.

### TECHNICAL FIELD

The present disclosure generally relates to a vehicle headliner.

### BACKGROUND

An interior portion of a vehicle can include a headliner formed of one or more layers of material to cover the metal surface of a body panel of the vehicle. The headliner can insulate a passenger cabin of the vehicle from noise and/or vibration.

### SUMMARY

In one form, the present disclosure is directed to a vehicle body component that includes a variable lattice body having a front side exposed to an interior environment of a vehicle and a plurality of segments connected to each other to define a plurality of voids forming an irregular lattice structure configured to twist on itself responsive to a vibrational energy.

In one form, the present disclosure is directed to a vehicle body component that includes a variable lattice body defined by a thermoplastic polyurethane material, and having a front side exposed to an interior environment of a passenger cabin of a vehicle and a plurality of segments connected to each other to define a plurality of voids forming an irregular lattice structure configured to twist on itself responsive to a vibrational energy. At least one of dimensions of segments, shape of voids, and/or dimension of void of the variable lattice body varies forming the irregular lattice structure.

### BRIEF DESCRIPTION OF THE DRAWINGS

FIG. 1 is an example vehicle having a vehicle body component in accordance with the present disclosure;

FIG. 2 is an example roof for the vehicle of FIG. 1 having the vehicle body component in accordance with the present disclosure;

FIG. 3A is a perspective view of an example vehicle body component in accordance with the present disclosure;

FIG. 3B is illustrate the vehicle body component of FIG. 3A with a portion of an exterior lattice structure removed in accordance with the present disclosure;

FIG. 3C is a partial cross-sectional view of the vehicle body component of FIG. 3A in accordance with the present disclosure;

FIG. 4A is a top view of an example lattice structure in accordance with the present disclosure;

FIG. 4B is a perspective view of the lattice structure of FIG. 4A in accordance with the present disclosure;

FIG. 5A is a top view of an example variable lattice body of the vehicle body component in accordance with the present disclosure;

FIG. 5B is a perspective view of the variable lattice body of FIG. 5A in accordance with the present disclosure;

FIG. 6 illustrates an example printer for forming the variable lattice structure in accordance with the present disclosure; and

FIG. 7 is a perspective view of an example detachable panel having the vehicle body component in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

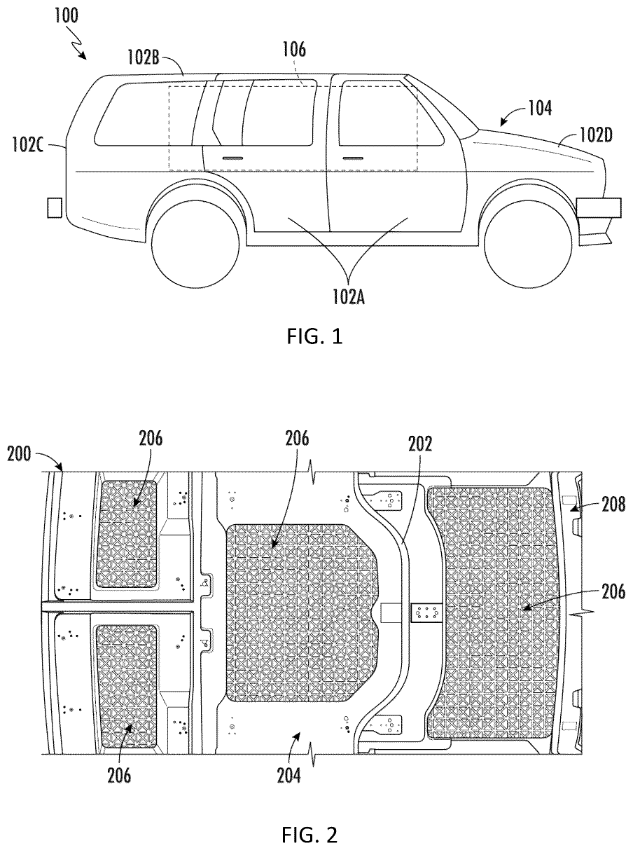

Referring to FIG. 1, a vehicle 100 includes a plurality of panels 102A, 102B, 102C, 102D (collectively “panels 102”) that are attached to a frame (not shown) to form a vehicle body 104 defining, at least, a passenger cabin 106 (illustrated as a dashed box). In a non-limiting example, the panels 102 may include one or more door panels 102A, one or more roof panels 102B, a rear panel 102C, and/or a hood panel 102D.

An interior portion of the vehicle body 104 forming the passenger cabin 106 may include a headliner formed of one or more layers of material to cover the bare metal surface of the panel 102 and to insulate the passenger cabin 106 from noise and/or vibration. In some forms, portions of the panels may be left exposed and may not have the headliner for various reasons, such as but not limited to, accommodating detachable panels and/or preference of the user based on usage of the vehicle (e.g., vehicle 100 is being used for transporting packages or equipment). In such instances, the passenger cabin 106 is left vulnerable to noise and/or vibration which can be unpleasant to passengers of the vehicle 100.

The present disclosure is directed a vehicle body component having a variable lattice body adapted to receive and dampen vibrational and sound energy. The variable lattice body is exposed to an interior environment of a vehicle to be visible to an occupant. The variable lattice body includes a plurality of segments connected to each other to define a plurality of voids forming a varying or an irregular lattice structure configured to twist on itself responsive vibrational energy. As detailed herein, at least a portion of the segments, at least a portion of the voids, or at least portions of both the segments and the voids have varying structural configuration (e.g., dimension, shape, and/or orientation) to transfer the energy into motion through the varying lattice structure. Accordingly, the vehicle body component dampens sounds/vibration while still providing predominately exposed metal interior.

While the vehicle 100 is illustrated as being a sports utility vehicle, the vehicle 100 may be other suitable vehicle types, such as but not limited to, a bus, a van, a truck, a coupe, an off-road vehicle, or a station wagon. In addition, while the vehicle 100 is illustrated as a four wheel vehicle, the vehicle 100 may include 2 or more wheels.

Referring to FIG. 2, a roof member 200, which may be used on vehicle 100 to form the roof of the vehicle 100, is adapted to have at least a portion of an interior surface 202 facing the passenger cabin exposed with no material. Specifically, in one form, the roof member 200 includes a primary body 204 with a plurality of vehicle body components 206 disposed at selected areas of the primary body 204. The primary body 204 may be formed of one or more panels 208, similar to panels 102.

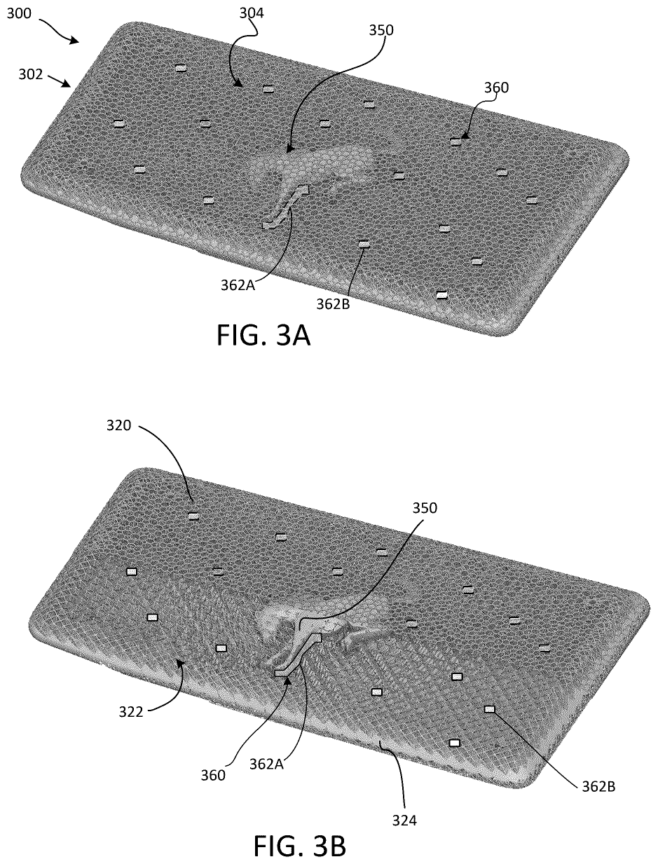

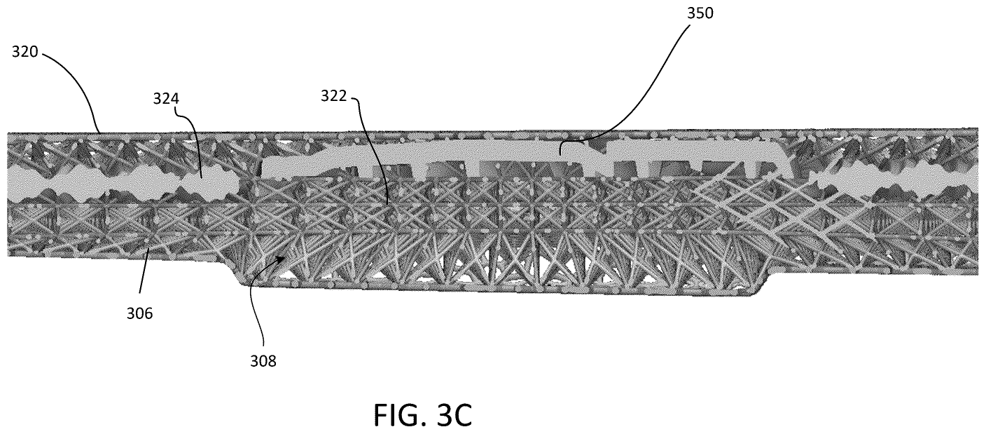

In one form, the vehicle body component 206 is configured to attenuate noise and vibrational energy. Specifically, referring to FIGS. 3A, 3B, and 3C, the vehicle body component 206 may be provided as a vehicle body component 300 that includes a variable lattice body 302 having a front side 304 exposed to an interior environment of the vehicle 100. The variable lattice body 302 includes a plurality of segments 306 connected to each other to define a plurality of voids 308 forming a varying or an irregular lattice structure configured to attenuate vibrational. In one form, the irregular lattice structure is defined such that two or more segments 306, two or more voids 308, or two or more segments 306 and two or more voids 308 are different in at least one of dimensions, orientation, and/or shape (i.e., at least one of dimensions of segments, shape of the segments, shape of the voids, and/or dimensions of the voids vary forming the irregular lattice structure).

In one form, the varying lattice body 302 defines an exterior lattice structure 320, one or more sound deadening layers 322, and an internal variable lattice structure 324. In one form, the exterior surface lattice 320 is configured to provide a desired aesthetic look of the vehicle body component 300. In addition, the exterior surface lattice 320 and the internal variable lattice structure 324 are adapted to receive sound and/or vibrational energy causing movement of the segments 306 and dampening the sound and/or vibrational energy. With the varying configuration, the exterior surface lattice 320 and the internal variable lattice structure 324 provides a flexible or, in other words, responsive body 302 in which the segments 306 may move linearly in various directions and/or slightly rotate providing a twisting motion of the segments 306 without causing permanent deformation of the varying lattice body 302.

The one or more sound deadening layers 322 are adapted to reduce or prevent sound and/or vibration from passing through the layer 222. The deadening layer 322 may be a single continuous layer or may be provided as multiple layers and/or portions having different shapes and/or dimensions that are discretely provided in the variable lattice body 302.

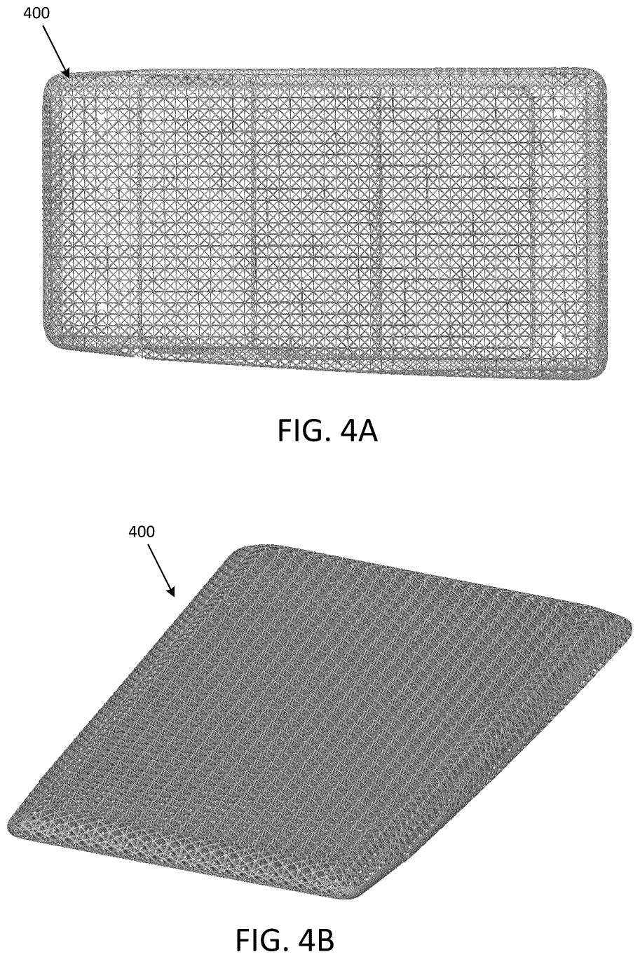

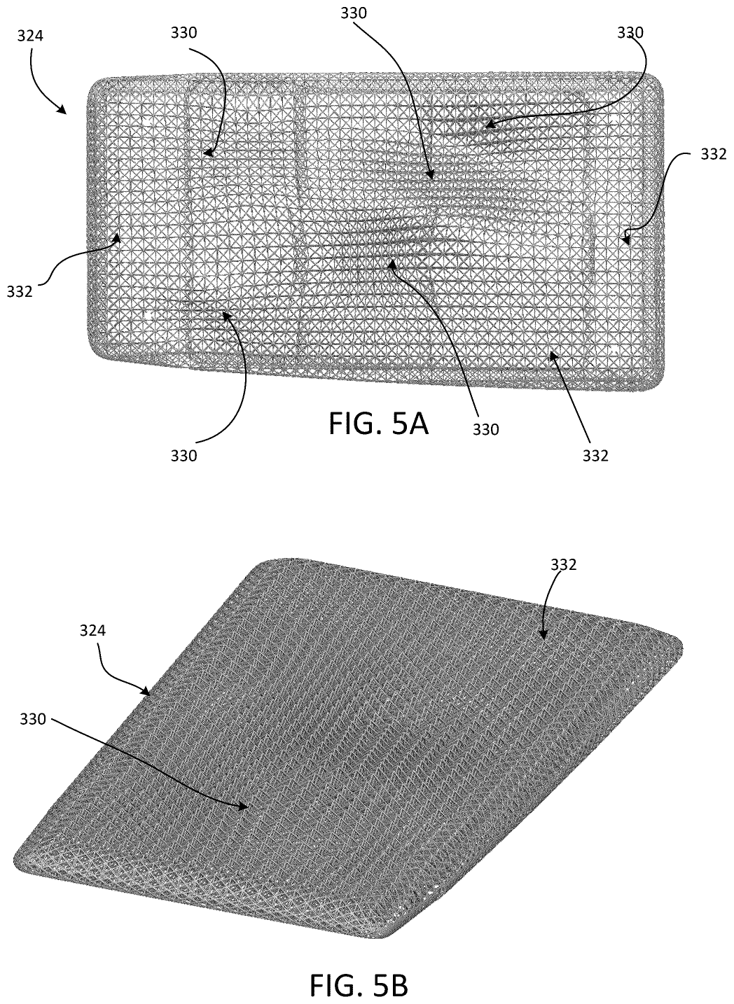

In a non-limiting example, with reference to FIGS. 4A, 4B, 5A, and 5B, to further illustrate the varying structure of the variable lattice body 302, the internal variable lattice structure 324 is viewed in association with a lattice structure 400 not having a varying configuration. In FIGS. 4A and 4B, the lattice structure 400 has a continuous uniform lattice structure with same lattice pattern being repeated evenly throughout. On the other hand, the internal variable lattice structure 324 has a warped or contorted like portions 330 with substantially linear/straight portions 332 to provide the irregular lattice structure defined by different lattice patterns. In one form, a set of segments 306 forming the contorted-like portions 330 may have different dimensions, orientation, and shape (e.g., shape can be straight, twisted, or a combination thereof). In one form, a set of segments 306 that form the linear portions 332 may substantially have a linear shape and different dimensions from one another.

In one form, one or more computer-aided design software application having vibration-sound analysis modeling may be used to define the specific structure of the variable lattice body 302 based on initial sound/vibration frequencies detected for a specific vehicle. Accordingly, the variable lattice body 302 having the exterior lattice structure 324, the sound deadening layers 322, and the internal variable lattice structure 324 should not be limited to the example structure provided in the figures.

In one form, the variable lattice body 302 is defined by a thermoplastic polyurethane (TPU) material, and formed using additive manufacturing techniques. TPU may be used as a class A-surface to be visible to a user, and thus does not require additional components for providing an aesthetic appearance. In addition, TPU has energy absorbing properties for aid in receiving and dampening sound/vibrational energy.

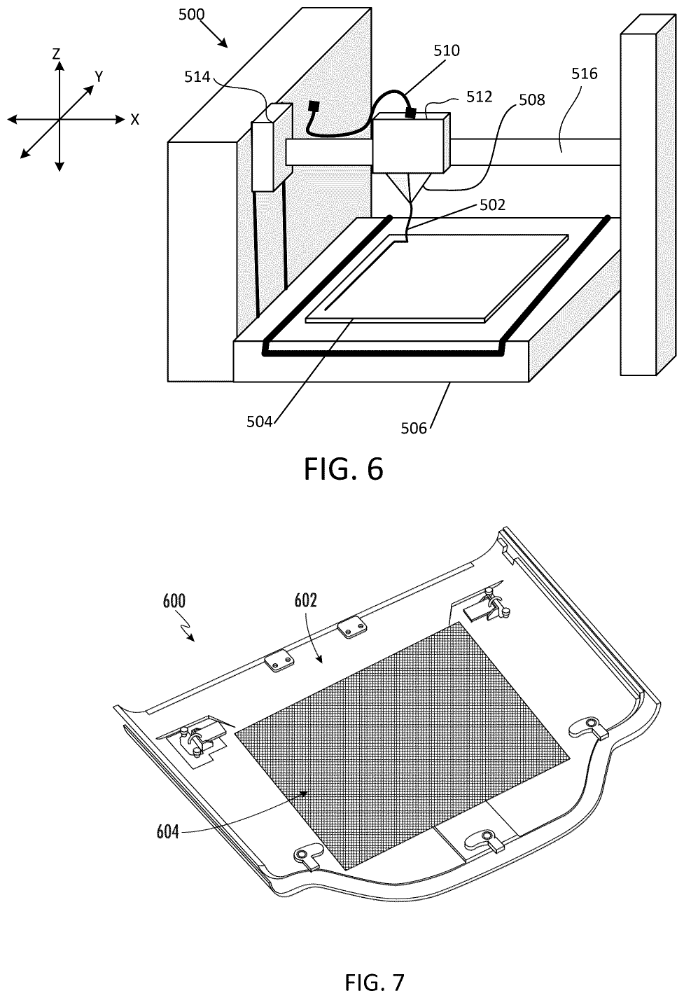

Referring to FIG. 6, in a non-limiting example, a three-dimensional (3D) printer 500 prints or, more specifically, deposits a TPU 502 onto a substrate 504 that is to be attached to the panel 102. The example 3D printer 500 includes a table 506 for supporting the substrate 504 and a nozzle 508 receiving the TPU material 502 from a material supply line 510 and depositing the TPU 502 onto the substrate 504. The table 506 and the nozzle 508 are moveable relative to one another along a 3D coordinate system. In a non-limiting example, the table 506 is moveable along a Y-axis, the nozzle 508 is attached to a carriage 512 that is moveable along an arm 514 extending along an X-axis, and the arm 514 is attached to another carriage 516 to move along the Z-axis.

It should be readily understood that other suitable 3D printers and/or techniques may be employed, and that the present disclosure is not limited to the printer 500 illustrated. For example, a multi-jet fusion style printing technique, which is a variant of composite selective laser sintering, may be used.

Once formed, the vehicle body component 300 having the substrate 504 and the variable lattice body 302 is connected to the panel 102 using one or more fastening techniques (e.g., screws, bolt, welding, and/or adhesives). In lieu of printing on the substrate 504, the variable lattice body 302 may be printed or, in other words, formed directly on to the panel 102, thereby being directly connected to the panel 102.

As briefly indicated above, the vehicle 100 may include detachable panels that can be secured to the vehicle 100. In a non-limiting example, FIG. 7 illustrates an example detachable panel 600 that is attachable to and detachable from a roof of a vehicle using fasteners 602. The detachable panel 600 includes a variable lattice body 604 on a side of the panel 600 that is to face the passenger cabin of the vehicle 100. The variable lattice body 604 is configured in a similar manner as the variable lattice body 302 of the present disclosure. While the detachable panel 600 is described as being attached to the roof, the detachable panel 600 may be connected to other suitable portions of the vehicle, such as, but not limited to side portions of the vehicle.

Continuing with FIGS. 3A, 3B, and 3C in some variations, the vehicle body component 300 may further include or define an emblem 350 to be exposed to the interior environment of the vehicle 100. With the variable lattice body 302 having class-A surface that is visible to the passenger, the variable lattice body 302 may include decorative designs. While the emblem 350 is illustrated as singular shape, the emblem 350 may include multiple parts that can include shapes, apertures, among other features distributed at one or more portions of the vehicle body component 300. In addition, the emblem 350 may be made of another material and is not limited to the same material as the variable lattice body 302, such as TPU.

In one form, the emblem 350 is defined within the variable lattice body 302 provided below at least one layer of a lattice structure of the variable lattice body 302 (e.g., below the exterior lattice structure 320) while still being visible to an occupant. Alternatively, the emblem 350 may be provided on a top surface of the variable lattice body 302 as part of the exterior lattice structure 320.

In another variation, the vehicle body component 300 may also include an illumination system 360 configured to illuminate at least a portion of the vehicle body component 300 using a light component that illuminates upon receiving electrical power. In a non-limiting example, the illumination system 360 may include an illumination film 362A, as the light component, provided, or more specifically, integrated with the variable lattice body 302. The illumination film 362A may be applied after the formation of the variable lattice body 302 or even during the formation of the variable lattice body 302, by applying the film 364 at desired regions of the vehicle body component 300 after the desired region is formed. In a non-limiting example, the film 364 is applied to at least a portion of the emblem 350 to highlight features of the emblem 350.

In addition to or in lieu of the illumination film 362A, the illumination system 360 includes one or more illumination devices 362B, as the light component, integrated with the vehicle body component 300 and more specifically, the variable lattice body 302. The illumination devices 362B may include, but is not limited to, one or more light emitting diodes (LEDs) provided at desired regions of the variable lattice body 302.

Electrical power may be provided in various suitable ways to the illumination system 360. In a non-limiting example, electrical contacts (not shown) may be provided at the vehicle body component 300, which may include the variable lattice body 302 or the panel/substrate having the variable lattice body 302. The electrical contacts are electrically coupled to a power source (e.g., a power bus of the vehicle or a battery) using wires and/or conductive film,

The various variations described herein may be provided individually or in combination with other variations.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle body component, comprising:
a variable lattice body having a front side exposed to an interior environment of a vehicle and a plurality of segments connected to each other to define a plurality of voids forming an irregular lattice structure configured to twist on itself responsive to a vibrational energy.

2. The vehicle body component of claim 1, wherein at least one of dimensions of segments, shape of voids, and/or dimension of void of the variable lattice body varies forming the irregular lattice structure.

3. The vehicle body component of claim 1, further comprising a body panel, the variable lattice body being connected to the body panel.

4. The vehicle body component of claim 3, wherein the variable lattice body is formed on the body panel.

5. The vehicle body component of claim 3, further comprising a substrate, the variable lattice body being formed on the substrate and connected to the body panel.

6. The vehicle body component of claim 3, wherein the body panel is a roof top panel.

7. The vehicle body component of claim 1, wherein a set of segments from among the plurality of segments form a contorted portion to permit at least a portion of the variable lattice body to twist in response to the vibrational energy.

8. The vehicle body component of claim 1, further comprising an illumination system configured to illuminate at least a portion of the variable lattice body and including an illumination film integrated with the variable lattice body and operable to illuminate in response to receiving electrical power.

9. The vehicle body component of claim 1, further comprising an illumination system configured to illuminate at least a portion of the variable lattice body and including one or more illumination device integrated with the variable lattice body and operable to illuminate in response to receiving electrical power.

10. The vehicle body component of claim 1, further comprising an emblem defined at the variable lattice body to be visible to the interior environment of the vehicle.

11. The vehicle body component of claim 1, wherein the variable lattice body is defined by a thermoplastic polyurethane material.

12. A method, comprising:
printing, using thermoplastic polyurethane material, the variable lattice body of the vehicle body component of claim 1.

13. A vehicle body component, comprising:
a variable lattice body:
defined by a thermoplastic polyurethane material, and
having a front side exposed to an interior environment of a passenger cabin of a vehicle and a plurality of segments connected to each other to define a plurality of voids forming an irregular lattice structure configured to twist on itself responsive to a vibrational energy,
wherein at least one of dimensions of segments, shape of voids, and/or dimension of void of the variable lattice body varies forming the irregular lattice structure.

14. The vehicle body component of claim 13, further comprising a body panel, the variable lattice body being connected to the body panel.

15. The vehicle body component of claim 14, wherein the variable lattice body is formed on the body panel.

16. The vehicle body component of claim 14, further comprising a substrate, the variable lattice body being formed on the substrate and connected to the body panel.

17. The vehicle body component of claim 13, wherein a set of segments from among the plurality of segments form a contorted portion to permit at least a portion of the variable lattice body to twist in response to the vibrational energy.

18. The vehicle body component of claim 13, further comprising an illumination system including an illumination film integrated with the variable lattice body and operable to illuminate in response to receiving electrical power.

19. The vehicle body component of claim 13, further comprising an illumination system configured to illuminate at least a portion of the variable lattice body and including one or more illumination device integrated with the variable lattice body and operable to illuminate in response to receiving electrical power.

20. The vehicle body component of claim 13, further comprising an emblem defined at the variable lattice body to be visible to the interior environment of the vehicle.
